(19) United States
(12) Patent Application Publication
(10) Pub. No.: US 2017/0053588 A1
(43) Pub. Date: Feb. 23, 2017

(54) DISPLAY PANEL AND DISPLAY DEVICE HAVING THE SAME

(71) Applicant: Samsung Display Co., Ltd., Yongin-si (KR)

(72) Inventors: Han Sin LIM, Yongin-si (KR); Sung Gi KIM, Yongin-si (KR)

(21) Appl. No.: 15/158,414

(22) Filed: May 18, 2016

(30) Foreign Application Priority Data
Aug. 18, 2015 (KR) 10-2015-0116109

(51) Int. Cl. G09G 3/20; G06F 1/32; G06F 1/28; G09G 3/3266; G09G 3/3275

(52) U.S. Cl. CPC G09G 3/2092; G09G 3/3266; G09G 3/3275; G06F 1/28; G06F 1/3234; G09G 2330/045; G09G 2330/12; G09G 2330/028; G09G 2330/025; G09G 2330/021

(57) ABSTRACT

A display panel includes: a substrate; a plurality of pixels on the substrate, the plurality of pixels including an emitting element; a power supply line on the substrate, the power supply line being configured to receive power supplied from a power supply; and a temperature sensor at a peripheral region of the power supply line and for sensing a temperature of the power supply line.

### CROSS-REFERENCE TO RELATED APPLICATION

This application claims priority to and the benefit of Korean Patent Application No. 10-2015-0116109, filed on Aug. 18, 2015, in the Korean Intellectual Property Office, the entire contents of which are incorporated herein by reference in their entirety.

### BACKGROUND

1. Field

Embodiments relate to a display panel and a display device having the same.

2. Description of the Related Art

Today, widely used devices such as computer monitors, TVs, mobile phones, and/or the like have display devices. Display devices, which display image using digital data, include a cathode-ray tube display, a liquid crystal display (LCD), a plasma display panel (PDP), an organic light emitting display (OLED) and/or the like. The rate of data transfer for the display device is increasing as the display device becomes more high-resolution and larger.

However, display devices typically use higher voltages than other suitable electronic devices do. Therefore, there is a high possibility for fire or for damage caused by excessive current due to a crack in the display panel or an abnormal short circuiting of the power line.

### SUMMARY

Embodiments relate to a display panel capable of sensing and preventing an overcurrent which may arise in case of a crack in the display panel or an abnormal short circuiting of the power supply line.

Embodiments further relate to a thin film transistor (TFT) with a circuit capable of detecting an overcurrent in the display panel mounted inside, leading to implementation at a low cost.

Embodiments further relate to a display panel capable of sensing and preventing an overcurrent based on the determination whether an overcurrent has occurred by sensing the temperature of the power supply line of the power supply and a display device including the same.

Embodiments further relate to a method of preventing an overcurrent capable of saving cost even when the number of power lead-in terminals increases due to an increase in the size of the display panel.

The technological goals contained herein are not limited to those mentioned above, and those not mentioned shall be understood clearly by a person of ordinary skill in the art from the description provided herein.

A display panel according to an embodiment may include: a substrate; a plurality of pixels on the substrate, the plurality of pixels including an emitting element; a power supply line on the substrate, the power supply line being configured to receive power supplied from a power supply; and a temperature sensor at a peripheral region of the power supply line and for sensing a temperature of the power supply line.

The temperature sensor may include a p-type-intrinsic-metal (p-i-m) diode or a p-type intrinsic n-type (p-i-n) diode.

The temperature sensor may be between the substrate and the power supply line.

The power supply line may include a first power supply line for receiving a first power from the power supply and a second power supply line for receiving a second power from the power supply.

The temperature sensor may include a first temperature sensor at a peripheral region of the first power supply line, the first temperature sensor being for detecting a temperature of the first power supply line and a second temperature sensor at a peripheral region of the second power supply line, the second temperature sensor being for sensing a temperature of the second power supply line.

The temperature sensor may include a temperature sensing sensor for changing a leakage current according to the temperature of the power supply line, a detection circuit for converting the leakage current of the temperature sensing sensor into a voltage and a comparator for comparing the voltage with a reference voltage and determine whether an overcurrent is generated.

The comparator may transmit signals to interrupt power supplied from the power supply to the power supply line when the voltage is greater than the reference voltage.

A display device according to an embodiment may include a display panel, a data driver for supplying data signals to the display panel, a scan driver for supplying scan signals to the display panel, and a power supply for supplying power to the display panel. The display panel may include a substrate, a plurality of pixels on the substrate, the plurality of pixels including an emitting element, a power supply line on the substrate, the power supply line being configured to receive a power supplied from the power supply, and a temperature sensor at a peripheral region of the power supply line and for sensing a temperature of the power supply line.

According to an embodiment, a display panel capable of sensing and preventing an overcurrent and a display device including the same may be provided.

Also, a thin film transistor (TFT) with a circuit capable of detecting an overcurrent in the display panel mounted inside may be implemented, leading to implementation at a low cost.

Also, a display panel capable of sensing and preventing an overcurrent based on the determination whether an overcurrent has occurred by sensing the temperature of the power supply line of the power supply and a display device including the same may be provided.

Also, a method of preventing an overcurrent capable of saving cost even when the number of power lead-in terminals increases due to an increase in the size of the display panel may be provided.

The effects which may be obtained here are not limited to those mentioned above, and those not mentioned should be understood clearly by any person of ordinary skill in the art from the description provided herein.

### BRIEF DESCRIPTION OF THE DRAWINGS

Example embodiments will now be described more fully hereinafter with reference to the accompanying drawings; however, the present invention may be embodied in different forms and should not be construed as limited to the embodiments set forth herein. Rather, these embodiments are provided so that this disclosure will be thorough and complete, and will fully convey the scope of the example embodiments to those skilled in the art.

In the drawings, dimensions may be exaggerated for clarity of illustration. It will be understood that when an element, component, region, layer, and/or section is referred to as being “between” two elements, components, regions, layers, and/or sections, it can be the only element, component, region, layer and/or section between the two elements, components, regions, layers, and/or sections, or one or more intervening elements, components, regions, layers, and/or sections, may also be present. Like reference numerals refer to like elements throughout.

FIG. 1 illustrates an example of a block diagram of a display device according to an embodiment.

FIG. 2 illustrates an example of a top view of a display panel with a temperature sensor according to an embodiment.

FIG. 3 illustrates an example of a sectional view of a display panel with a temperature sensor according to an embodiment.

FIG. 4 illustrates another example of a top view of a display panel with a temperature sensor according to an embodiment.

FIG. 5 illustrates another example of a sectional view of a display panel with a temperature sensor according to an embodiment.

FIGS. 6A and 6B illustrate an example of perspective views of a temperature sensor implemented diode according to an embodiment.

FIG. 7 illustrates an example of a temperature sensor according to an embodiment.

FIG. 8 illustrates an example of leakage current of a temperature sensor according to an embodiment.

FIG. 9 illustrates another example of operations of a temperature sensor according to an embodiment.

FIG. 10 illustrates a block diagram of a display device according to an embodiment.

FIG. 11 illustrates an example of a sensing circuit based on a thin film transistor according to an embodiment.

FIG. 12 illustrates a timing diagram of a sensing circuit according to an embodiment.

FIG. 13 illustrates an example of a comparator using Schmidt Trigger according to an embodiment.

FIG. 14 illustrates a timing diagram of a comparator according to an embodiment.

FIG. 15 illustrates an example of an analog-digital converter using a comparator according to an embodiment.

### DETAILED DESCRIPTION

In the following detailed description, only certain exemplary embodiments of the present invention have been shown and described, simply by way of illustration. As those skilled in the art would realize, the described embodiments may be modified in various suitable different ways, all without departing from the spirit or scope of the present invention. Accordingly, the drawings and description are to be regarded as illustrative in nature and not restrictive.

It will be understood that when an element or layer is referred to as being “on,” “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer, or one or more intervening elements or layers may be present. Further “connection,” “connected,” etc. may also refer to “electrical connection,” “electrically connect,” etc. depending on the context in which they are used as those skilled in the art would appreciate. When an element or layer is referred to as being “directly on,” “directly connected to,” “directly coupled to,” “directly connected with,” “directly coupled with,” or “immediately adjacent to” another element or layer, there are no intervening elements or layers present.

Like numbers refer to like elements (or components) throughout. As used herein, the term “and/or” includes any and all suitable combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

It will be understood that, although the terms “first,” “second,” “third,” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the teachings of the present invention.

Spatially relative terms, such as “beneath”, “below”, “lower”, “under,” “above”, “upper” and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below,” “beneath,” or “under” other elements or features would then be oriented “above” the other elements or features. Thus, the exemplary term “below” and “under” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments and is not intended to be limiting of the invention. As used herein, the singular forms, “a” and “an” are intended to include the plural forms as well, unless the context clearly indicates otherwise. It will be further understood that the terms “comprise,” “comprises,” “comprising,” “includes,” “including,” and “include,” when used in this specification, specify the presence of stated features, integers, steps, operations, elements, and/or components, but do not preclude the presence or addition of one or more other features, integers, steps, operations, elements, components, and/or groups thereof.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

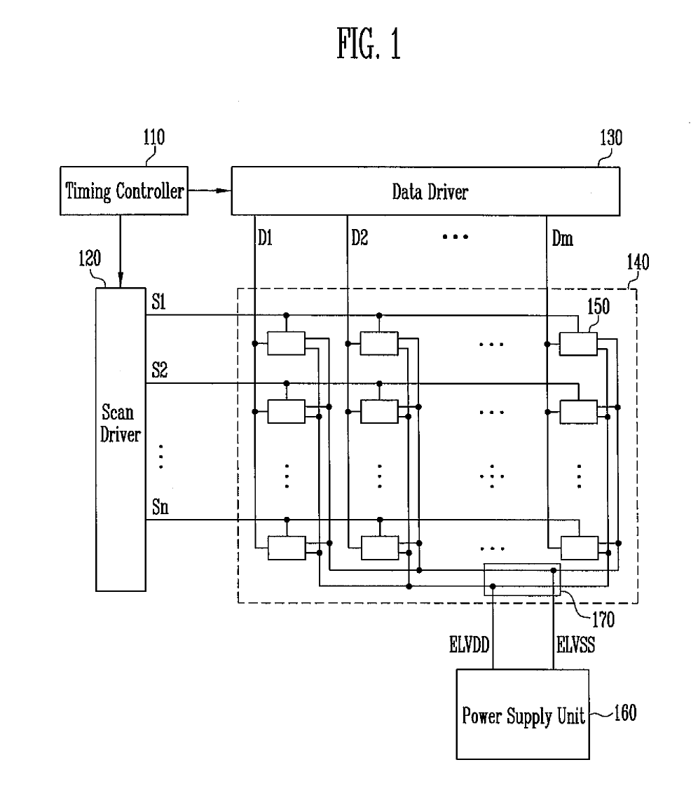

FIG. 1 is a block diagram of an example of a display device according to an embodiment.

Referring to FIG. 1, a display device according to an embodiment may include a timing controller 110, a scan driver 120, a data driver 130, a display panel 140, and a power supply (or power supply unit) 160.

The timing controller 110 may respond to a synchronization signal supplied from outside and control operations of the scan driver 120 and the data driver 130. In other words, the timing controller 110 may generate a scan drive control signal and supply the scan drive control signal to the scan driver 120. The timing controller 110 may generate a drive control signal and supply the drive control signal to the data driver 130. Furthermore, the timing controller 110 may output data, supplied from outside, to the data driver 130.

The scan driver 120 may respond to a scan driving signal output from the timing controller 110 and supply scan driving signals sequentially to scan lines S1 to Sn.

In addition, the data driver 130 may, in response to a data drive control signal that is output from the timing controller 110, rearrange data output from the timing controller 110 and supply it to data lines D1 to Dm.

The display panel 140 may include a plurality of rows and columns of pixels 150 arranged in a matrix structure. The pixels 150 may be arranged at crossing regions of the data lines D1 to Dm and scan line S1 to Sn. And the pixels 150 may include light emitting elements such as organic light emitting diodes (OLED) and/or the like. Light from the pixels 150 may be emitted using first power supplied from a first power supply line ELVDD, and second power from a second power supply line ELVSS. Here, the power supply 160 may supply the first power to the first power supply line ELVDD and the second power to the second power supply line ELVSS.

Because a display panel in general uses higher voltage than other electronic appliances do, if there is a crack in the display panel or an abnormal short circuiting of the power line, there is an increased possibility of fire, due to an overcurrent, and that there will be damage caused by the fire. For example, if there is a crack in the display panel, current may flow through the crack, and as a result, an overcurrent may flow through the power supply line.

Some embodiments of the present invention provide an overcurrent sensor at every route that electric current flows to detect an overcurrent. In other words, an overcurrent from the power supply 160 may be detected by placing a separate current sensor between the power supply 160 and the display panel 140. Here, the overcurrent sensor may include an overcurrent sensing circuit which includes resistance that detects a current, an op-amp, a microprocessor (MCU), and/or the like, and which is capable of determining that there is an overcurrent when current higher than a certain threshold is detected for over a certain amount of time and preventing power from being supplied by the power supply 160. Circuits may be located on power/source printed board assembly (PBA), which is bonded to integrated circuit film at the top and bottom of the display panel. An overcurrent sensing circuit may be located at every film lead-in terminal, to which power from the power supply 160 is supplied. The overcurrent sensing circuit may detect voltage by placing resistance on current routes, which extend from the power supply unit, store it in the microprocessor, and determine whether there is an overcurrent based on it.

An overcurrent sensing circuit is used on every power route by which power from the power supply is provided to the display panel from the PBA. Therefore, the number of power lead-in terminals may increase as display panels become larger, and accordingly costs may increase due to an increase in the number of overcurrent sensing circuits. Also, current sensing fire protection-related costs of material may increase as display panels become larger.

In a display device according to an embodiment of the present invention, a method of internalizing a sensing circuit for determining whether an overcurrent flows in a display panel may be provided.

In a display device according to an embodiment of the present invention, when power from the power supply 160 is supplied to the panel through film bonded to the power supply 160, the power supply 160 may be coupled to the display panel 140 through wiring on a bonding pad of the panel. Here, when an overcurrent on a power route from the power supply 160 occurs, heat may be generated in power wiring. In other words, because the degree to which heat will be generated while operating within normal operational range is taken into consideration when the wiring is being laid out, heat above an allowed level may be generated when there is an overcurrent. Therefore, a temperature sensor 170, which detects the temperature of the power wiring, may be provided on a substrate of the display panel, such that it may be determined whether there has been an overcurrent by sensing the temperature of the power wiring.

In other words, the temperature sensor 170 formed around the power wiring of the display panel may determine that an overcurrent has occurred in the power wiring when heat over a critical temperature (e.g., a predetermined critical temperature) has occurred in the power wiring. Here, according to an embodiment, the temperature sensor 170 may be implemented with p-i-m (p-type-intrinsic-metal) diode or p-i-n (p-type-intrinsic-n-type) diode. Furthermore, according to an embodiment, the temperature sensor 170 may be provided below the power wiring, that is, between the substrate of the display panel and the power wiring to sense the temperature of the power wiring.

In further detail, the temperature sensor 170 formed around the power wiring of the display panel may detect temperature on the display panel by using changes in leakage current caused by changes in the temperature of the power wiring. And the temperature sensor 170 may determine that there has been an overcurrent when detected heat is greater than (or equal to or greater than) a critical temperature (e.g., a predetermined critical temperature). Here, according to an embodiment, the temperature sensor 170 may convert leakage current into voltage, compare the converted voltage with the critical voltage (e.g., the predetermined critical voltage), and determine that there has been an overcurrent when the converted voltage is greater than (or equal to or greater than) a critical voltage. In addition, when it is determined that there has been an overcurrent, the temperature sensor 170 may transmit a signal to the power supply 160 to interrupt (or block) the power supplied by the power supply 160. Accordingly, the power supply 160 may interrupt (or block) the supplied power according to a signal with information to interrupt (or block) the supplied power when there has been an overcurrent.

Accordingly, having the temperature sensor 170 formed on the display panel to detect the temperature of the power wiring in order to determine whether there has been an overcurrent may lead to lower costs because the temperature sensor, circuits, and/or the like which determine whether there has been an overcurrent are all implemented on the display panel through thin film process.

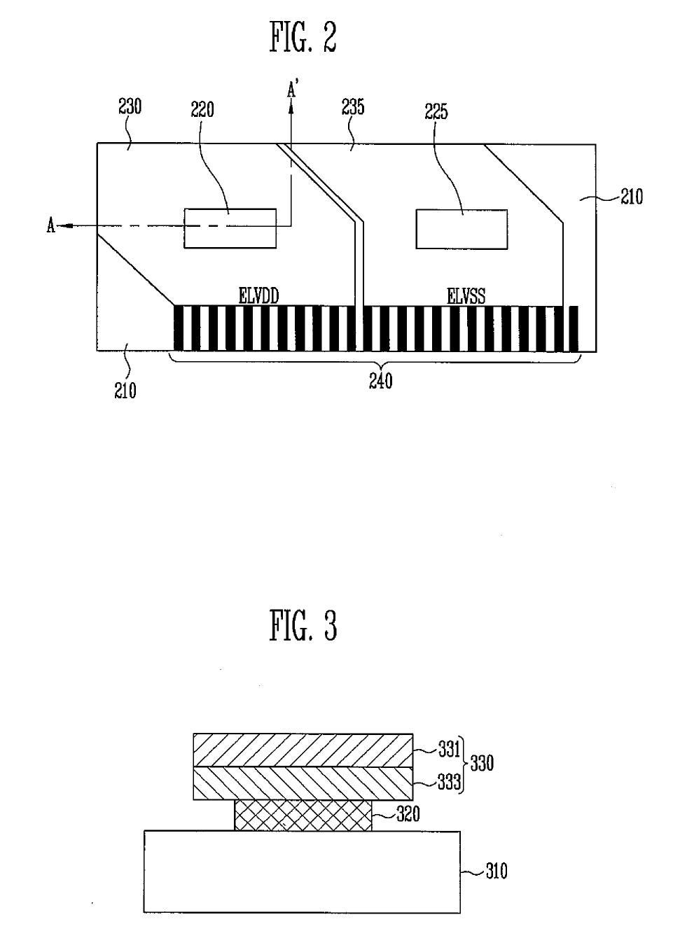

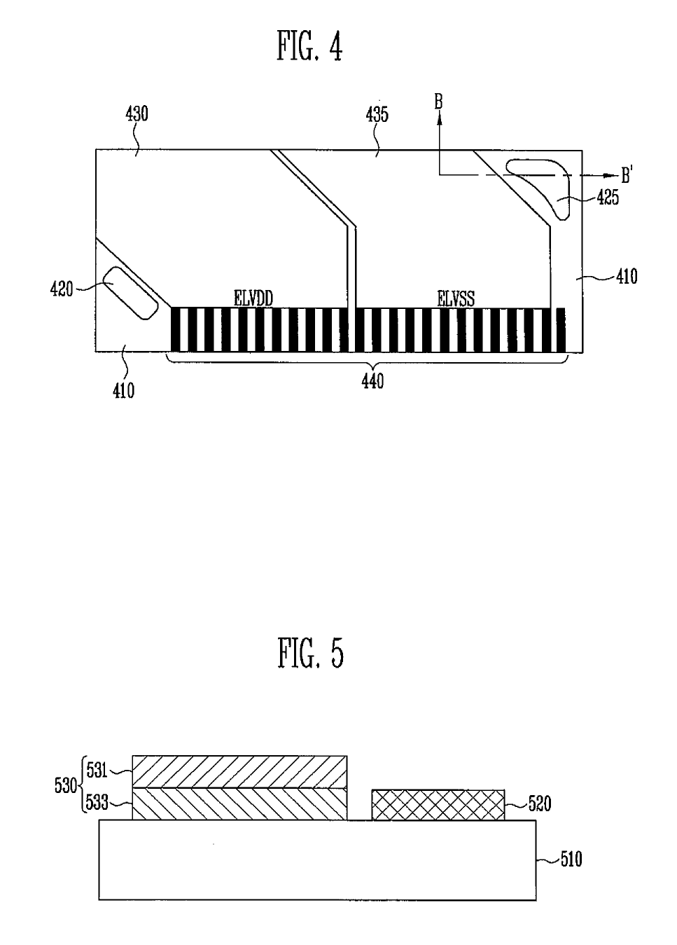

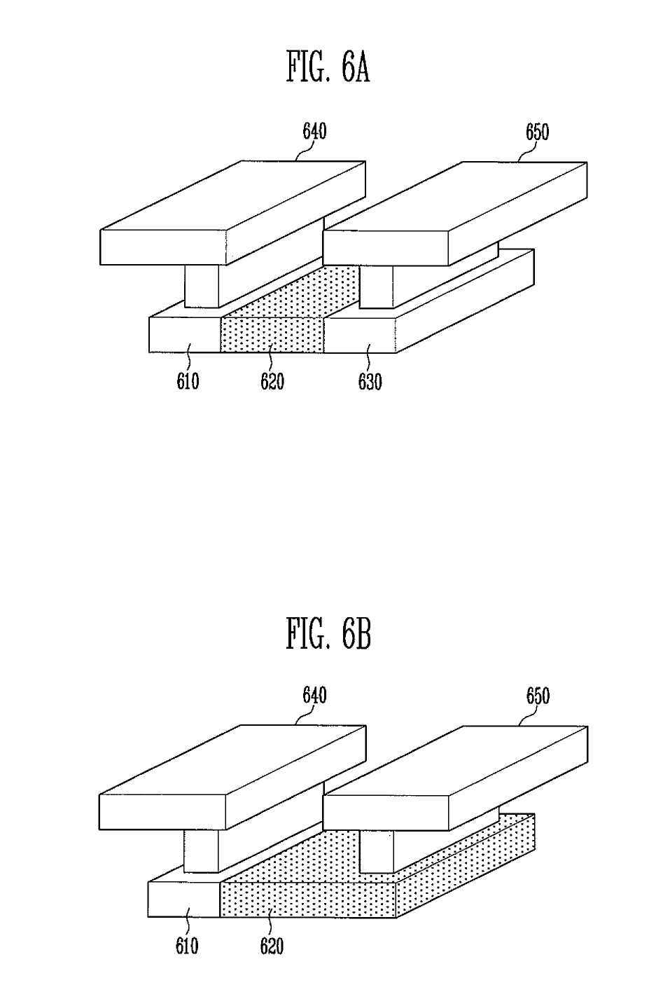

FIG. 2 illustrates an example of a top view of a display panel with a temperature sensor according to an embodiment. FIG. 3 illustrates an example of a sectional view of a display panel with a temperature sensor according to an embodiment. FIG. 4 illustrates another example of a top view of a display panel with a temperature sensor according to an embodiment. FIG. 5 illustrates another example of a sectional view of a display panel with a temperature sensor according to an embodiment. FIGS. 6A and 6B illustrate perspective views of temperature sensor implemented diodes according to example embodiments.

Referring to FIG. 2, a display panel of a display device according to an embodiment may include a substrate 210, a bonding pad 240 which supplies power from the power supply to the display panel, and power supply lines 230 and 235 by which power is supplied from the power supply unit. Temperature sensors 220 and 225 may be formed below the power supply lines 230 and 235, respectively. In other words, temperature sensors 220 and 225 may be formed between the substrate 210 of the display panel and the power supply lines 230 and 235. Here, according to an embodiment, the substrate 210 may include glass.

When, according to an embodiment, the first power and the second power are supplied from the power supply unit, the display panel may include a first power supply line ELVDD 230 and a second power supply line ELVSS 235, which are supplied, respectively, with the first power and the second power from the power supply unit. The display panel may further include a first temperature sensor 220 and a second temperature sensor 225, which are formed below the first power supply line 230 and the second power supply line 235, respectively. The first temperature sensor 220 may measure the temperature of the first power supply line 230, and the second temperature sensor 225 may measure the temperature of the second power supply line 235. The temperature sensors 220 and 225 may determine whether there has been an overcurrent in the power supply lines 230 and 235, respectively.

Also, FIG. 3 is a sectional view taken along the line A-A′ of a display panel according to an embodiment. Referring to FIG. 3, the temperature sensor 320 may be formed on the substrate 310, and the power wiring 330 may be formed thereon. The power wiring may be a double-layer structure including a first conductive layer 331 and a second conductive layer 333. The first conductive layer 331 may be composed of the same or substantially the same material as a source/drain S/D electrode, and the second conductive layer 333 may be composed of the same or substantially the same material as a gate electrode.

Operations of the temperature sensors 220 and 225 will be discussed in further detail. When there is an overcurrent in the power route, heating may occur in the power wiring, for example, first power supply line 230 and/or the second power supply line 235. As stated above, the extent to which heat is generated under normal operation conditions is taken into consideration when wiring layout is designed, so when there is an overcurrent, heat over a critical value (e.g., a predetermined critical value) may occur in the power wiring.

Therefore, when temperature sensors 220 and 225 are located below the power supply lines 230 and 235, the temperature sensors 220 and 225 may sense the temperature of the power supply lines 230 and 235. The temperature sensors 220 and 225 may determine whether there has been an overcurrent based on whether the temperature of the power supply lines 230 and 235 is higher than the critical temperature (e.g., the predetermined critical temperature). Or according to an embodiment, the temperature sensors 220 and 225 may convert leakage current into voltage, compare the converted voltage with a critical voltage (e.g., a predetermined critical voltage), and determine that there is an overcurrent when the converted voltage is higher than the critical voltage. When it is determined that there has been an overcurrent, the temperature sensors 220 and 225 may transmit a signal to interrupt (or block) the power supplied by the power supply unit. Accordingly, the power supply unit, when there is an overcurrent, may interrupt (or block) the power according to the signal with information to interrupt (or block) the power.

When there is a plurality of power supply lines from the power supply unit, for example, when there are two power supply lines, the first power supply line 230 and the second power supply line 235, the first temperature sensor 220 and the second temperature sensor 225 may be formed below the first power supply line 230 and the second power supply line 235. In this case, the first temperature sensor 220 and the second temperature sensor 225 may detect the temperature of the first power supply line 230 and the second power supply line 235, respectively. Accordingly, whether there is an overcurrent in the first power supply line 230 and/or the second power supply line 235 may be determined.

Referring to FIG. 4, a display panel of a display device according to an embodiment may include a bonding pad 440 which supplies power from the power supply to the display panel and power supply lines 430 and 435, to which power from the power supply is supplied. The temperature sensors 420 and 425 may be formed in the peripheral region of the power supply lines 430 and 435. In other words, the temperature sensors 420 and 425 may be located, not between the power supply lines 430 and 435 and the substrate 410, as in the embodiment shown in FIG. 2, but in the peripheral region of the power supply lines 430 and 435. For example, the temperature sensors 420 and 425 may be formed in regions where power supply lines 430 and 435 are not formed, as shown in FIG. 4. In other words, the temperature sensors 420 and 425 may be formed next to the power supply lines 430 and 435 and alongside the power supply lines 430 and 435. According to an embodiment, the substrate 410 may include glass.

According to an embodiment, when the first power and the second power are supplied from the power supply unit, the display panel may include a first power supply line ELVDD 430 and a second power supply line ELVSS 435, to which the first power and the second power are supplied from the power supply unit, respectively. The display panel may include a first temperature sensor 420 and a second temperature sensor 425 which are formed in the peripheral region of the first power supply line 430 and the second power supply line 435. The first temperature sensor 420 may sense the temperature of the first power supply line 430, and the second temperature sensor 425 may detect the temperature of the second power supply line 435. The temperature sensors 420 and 425 may determine whether there has been an overcurrent in the power supply lines 430 and 435, respectively.

FIG. 5 is a sectional view of a cross section of B-B′ of the display panel according to the embodiment of FIG. 4. Referring to FIG. 5, a temperature sensor 520 may be formed at a side of the power wiring 530 in regions different from those where the power wiring 530 is formed. The power wiring may be a double-layer structure including a first conductive layer 531 and a second conductive layer 533. The first conductive layer 531 may be composed of the same or substantially the same material as a source/drain S/D electrode, and the second conductive layer 533 may be composed of the same or substantially the same material as a gate electrode.

The operation of the temperature sensors 420 and 425 will be described more fully hereinafter. When there is an overcurrent in the power route, heating may occur in the power wiring, for example, the first power supply line 430 and/or the second power supply line 435. As stated above, the extent to which heat will occur within normal operations is taken into consideration when the wiring is laid out, so when there is an overcurrent, there may be heat over a critical value (e.g., a predetermined critical value). When the temperature sensors 420 and 425 are located in the peripheral region of the power supply lines 430 and 435, the temperature sensors 420 and 425 may detect the temperature of the power supply lines 430 and 435, respectively, and determine whether there has been an overcurrent by determining whether the temperature of either of the power supply lines 430 and 435 is higher than the critical temperature (e.g., the predetermined critical temperature).

According to an embodiment, the temperature sensors 420 and 425 may convert leakage current into voltage, compare the converted voltage with a critical voltage (e.g., a predetermined critical voltage), and determine that there is an overcurrent when the converted voltage is higher than the critical voltage. When it is determined that there has been an overcurrent, the temperature sensors 420 and 425 may transmit a signal to interrupt (or block) the power supplied from the power supply unit. Accordingly, the power supply unit, when an overcurrent is generated, may interrupt (or block) the power according to a signal having information to interrupt (or block) the power. Here, when there are a plurality of power supply lines from the power supply unit, for example, when there are two power supply lines, the first power supply line 430 and the second power supply line 435, the first temperature sensor 420 and the second temperature sensor 425 may be formed in the peripheral region of the first power supply line 430 and the second power supply line 435, respectively. In this case, the first temperature sensor 420 and the second temperature sensor 425 may sense the temperature of the first power supply line 430 and the second power supply line 435, respectively, and determine whether there is an overcurrent in the first power supply line 430 and the second power supply line 435, respectively.

Temperature sensors of the temperature sensors 220, 225, 320, 420, 425 and 520 may be implemented with a p-type-intrinsic-metal (p-i-m) diode or a p-type-intrinsic-n-type (p-i-n) diode. FIG. 6A shows a p-i-n diode, and FIG. 6B shows a p-i-m diode.

The p-i-n diode depicted in FIG. 6A may include a p-type doped region 610, an intrinsic semiconductor region 620, and an n-type doped region 630, and be coupled to metal plates 640 and 650 on the p-type doped region 610 and the n-type doped region 630, respectively.

The p-i-m diode depicted in FIG. 6b may include a p-type doped region 610 and an intrinsic semiconductor region 620 and be connected to metal plates 640 and 650 on the p-type doped region 610 and the intrinsic semiconductor region 620 respectively. In other words, unlike the p-i-n diode, the p-i-m diode does not include an n-type doped poly-Si region. However, the p-i-m diode may perform electrical functions almost the same or substantially the same as those of the p-i-n diode. Furthermore, the p-i-m diode requires only a p-type doping, thereby reducing cost.

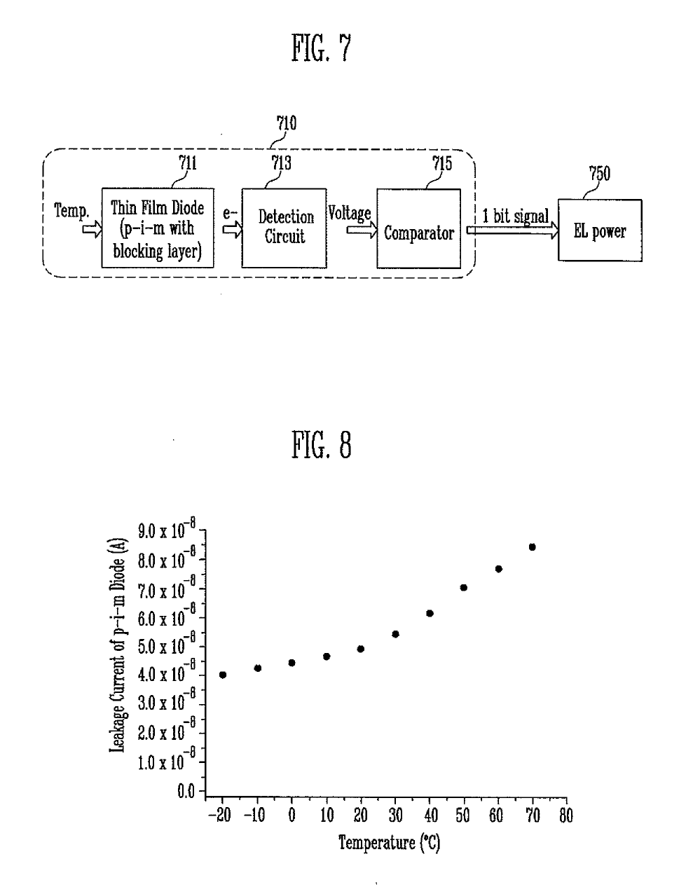

FIG. 7 illustrates an example of a temperature sensor according to an embodiment, and FIG. 8 illustrates an example of leakage current of a temperature sensor according to a temperature according to an embodiment.

Referring to FIG. 7, a temperature sensor 710 according to an embodiment may be formed on a substrate of the display panel. The temperature sensor may include a temperature sensor 711, a detection circuit 713, and a comparator 715. Here, according to an embodiment, the temperature sensor 711 may be a thin film diode. The thin film diode may, as stated above, be a p-i-m diode or a p-i-n diode. For example, leakage current of the p-i-m diode 711 may change according to changes in temperature, as shown in FIG. 8. In other words, leakage current of the p-i-m diode 711 may increase as temperature increases. Therefore, temperature may be detected on the display panel using this characteristic.

In other words, the temperature of the power wiring on the display panel may change as the amount of the current which flows in the power wiring changes. That is, the temperature of the power wiring may increase when the current in the power wiring increases. Here, according to an embodiment, because temperature sensors are located around the power wiring on the display panel, the amount of the leakage current of the thin film diode 711 of the temperature sensor may change as the size of the current in the power wiring changes. In other words, when the current in the power wiring increases, the size of the leakage current of the thin film diode 711 may increase. Here, the detection circuit 713 may detect the leakage current of the thin film diode 711, convert it into voltage, and relay it to the comparator 715.

The comparator 715 may compare the received converted voltage with a reference voltage (e.g., a predetermined reference voltage) and determine whether there has been an overcurrent in the power route. Here, the comparator 715 may determine that there has been an overcurrent when the received converted voltage is greater than the reference voltage (e.g., the predetermined reference voltage) and transmit a corresponding signal as an enable signal to the power supply 750.

Here, according to an embodiment, the signal which the comparator 715 transmits to the power supply 750 may be a 1-bit signal which indicates whether there has been an overcurrent. For example, the comparator 715 may send signal ‘1’ to the power supply 750, when the input voltage is greater than the reference voltage (e.g., the predetermined reference voltage), that is, when it is determined that the temperature of the power wiring is higher than the critical temperature (e.g., the predetermined critical temperature). Also, the comparator 715 may transmit signal ‘0’ to the power supply 750, when the input voltage is not greater than the reference voltage (e.g., the predetermined reference voltage), that is, when it is determined that the temperature of the power wiring is lower than the critical temperature.

According to an embodiment, when there is an overcurrent, that is, when the temperature of the power wiring is higher than the critical temperature (e.g., the predetermined critical temperature), or when the voltage converted from leakage current of the thin film diode 711 is higher than the reference voltage (e.g., the predetermined reference voltage), the comparator 715 may transmit a signal with information to stop power supplied to the power supply 750.

Afterwards, the power supply 750 may interrupt (or block) or continue power supply according to a signal received from the comparator 715. For example, when the power supply 750 receives a signal from the comparator 715 which indicates that there has not been an overcurrent, for example, signal ‘0,’ the power supply 750 may continue power supply to the display panel. When the power supply 750 receives a signal from the comparator 715 which indicates that there has been an overcurrent, for example, signal ‘1,’ the power supply 750 may interrupt (or block) the power to the display panel. In the case in which the comparator 715 transmits to the power supply 750 a signal to interrupt (or block) the power only when there has been an overcurrent, the power supply 750 which has received such a signal may interrupt (or block) the power.

In this case, because the temperature sensor 711, the detection circuit 713, the comparator 715, etc. are all realized on the display panel through the thin film process, there may be significant savings.

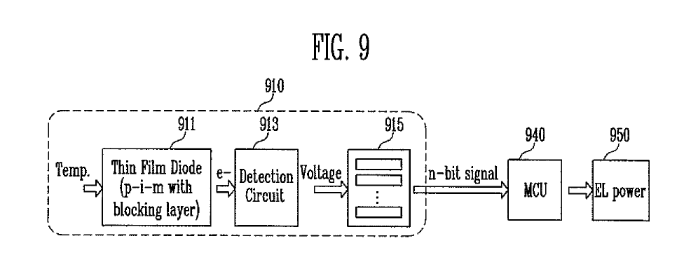

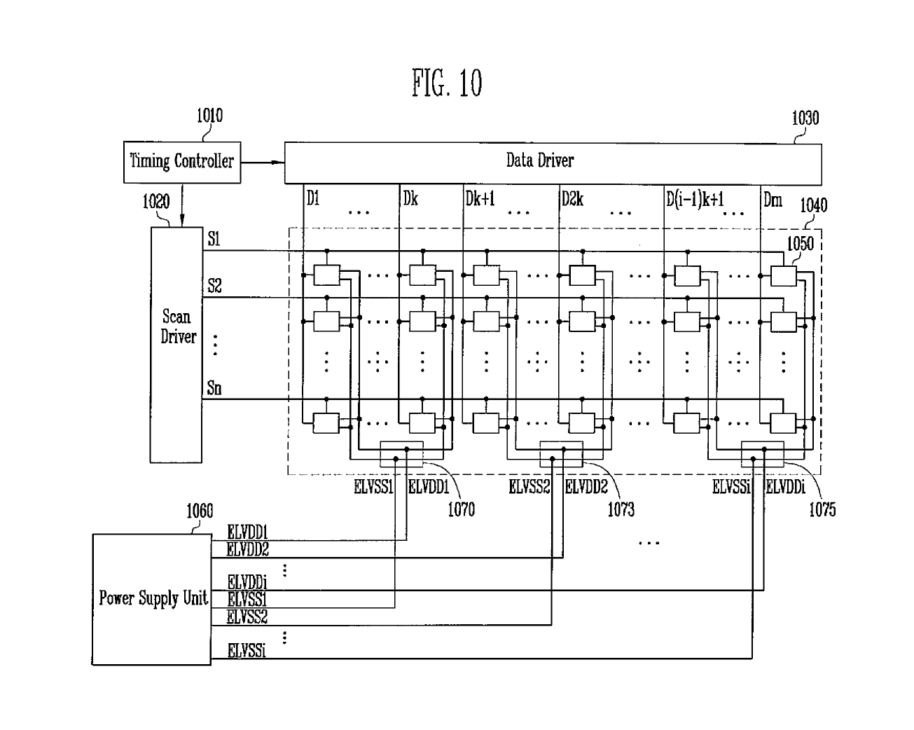

FIG. 9 is a diagram illustrating another example of an operation of a temperature sensor according to an embodiment.

Referring to FIG. 9, a temperature sensor 910 may be formed on a substrate of the display panel. The temperature sensor may include a temperature sensor 911, a detection circuit 913, and a plurality of comparators 915. Here, according to an embodiment, the temperature sensor 911 may be a thin film diode. The thin film diode, as stated above, may be a p-i-m diode, or a p-i-n diode. For example, the leakage current of the p-i-m diode 911 may change as temperature changes as shown in FIG. 8. In other words, the leakage current of the p-i-m diode 911 may increase as temperature increases. Therefore, using this characteristic, temperature detection may be possible on the display panel.

In other words, the temperature of the power wiring on the display panel may change as the size of the current in the power wiring changes. That is, the temperature of the power wiring may increase when the current in the power wiring increases. Here, according to an embodiment, because temperature sensors are located around the power wiring on the display panel, the amount of the leakage current of the thin film diode 911 of a temperature sensor may change depending on the size of the current flowing in the power wiring. In other words, when there is an increase in the current in the power wiring, the amount of the leakage current increases. Here, the detection circuit 913 may detect the leakage current of the thin film diode 911, convert it into voltage, and relay it to the comparator 915.

The comparator 915 may convert voltage received from the detection circuit 913 and convert it into an n-bit signal using a plurality of comparators. Here n may be the number that is the same as the number of comparators. In FIG. 7, one comparator may compare voltage received from the detection circuit 913 with the existing stored reference voltage and determine whether there has been an overcurrent. However, in FIG. 9, voltage received from the detection circuit 913 may be converted to an n-bit signal and transmitted to a microprocessor 940 outside the display panel. FIG. 9 shows three comparators 915 are included, but 2 or more, or 4 or more comparators 915 may exist. Here, the plurality of comparators 915 may form bit of “1” when voltage higher than the reference voltage (e.g., the predetermined reference voltage) is formed, and bit of “0” in other circumstances. For example, when there are 5 comparators 915, voltage received from the detection circuit 913 may be compared with values predetermined by first through fifth comparators respectively. Here, it may be assumed that the received voltage is lower than a first comparison voltage and a second comparison voltage and higher than a third comparison voltage through a fifth comparison voltage. In this case, a first comparator may output “0,” a second comparator “0,” a third comparator “1,” a fourth comparator “1,” and a fifth comparator “1,” resulting in a 5 bit-signal such as “00111.” With this, the comparator 915 may transmit a more precise voltage value to the microprocessor 940. The more the comparators 915 are, the more precise a value may be transmitted to the microprocessor 940.

The microprocessor 940 may use the received voltage value, the n-bit signal, and determine whether there has been an overcurrent using this value. In other words, the microprocessor 940 may save the temperature in normal conditions and transmit a signal with information to interrupt (or block) the power supplied from the power supply 950 when there has been an overcurrent.

Afterwards, the power supply 950 may, according to signals received from the microprocessor 940, interrupt (or block) or continue to supply the power. For example, when the power supply 950 receives a signal indicating that there has not been an overcurrent (or no signal), the power supply 950 may continue supplying power to the display panel. When the power supply 950 receives a signal indicating that there has been an overcurrent, the power supply 950 may interrupt (or block) the power supplied to the display panel.

In this case, the number of comparators and interface signals may increase, but there may be no reason why reference voltage, which indicates an overcurrent within the display panel, should be saved (or stored).

FIG. 10 illustrates an example of a block diagram of a display device according to another embodiment.

Referring to FIG. 10, a display device according to an embodiment may include a timing controller 1010, a scan driver 1020, a data driver 1030, a display panel 1040, pixels 1050, and a power supply 1060. Here, the display device may be substantially the same as the display device shown in FIG. 1, except that it includes a plurality of first power supply lines ELVDD1 to ELVDDi and a plurality of second power supply lines ELVSS1 to ELVSSi. Therefore, detailed description of those components that are substantially the same may be omitted.

The plurality of the first power supply lines ELVDD1 to ELVDDi each may supply the first power to certain corresponding regions of the entire region of the display panel 1040. The plurality of the second power supply lines ELVSS1 to ELVSSi each may supply the second power to certain corresponding regions of the entire region of the display panel 1040. The power supply 1060 may supply the first power to the plurality of the first power supply lines ELVDD1 to ELVDDi, and the second power to the plurality of the second power supply lines ELVSS1 to ELVSSi.

In a display device according to an embodiment, a plurality of temperature sensors 1070, 1073, and 1075, which detect the temperature of the plurality of the power wiring ELVDD1 to ELVDDi and ELVSS1 to ELVSSi from the power supply 1060 may be provided on the substrate of the display panel, and it may be determined whether there has been an overcurrent by detecting the temperature of the power wiring. In other words, the temperature sensors 1070, 1073 and 1075, which were formed around the power wiring of the display panel, may determine that there has been an overcurrent in the power wiring when there is heat over a critical temperature (e.g., a predetermined critical temperature).

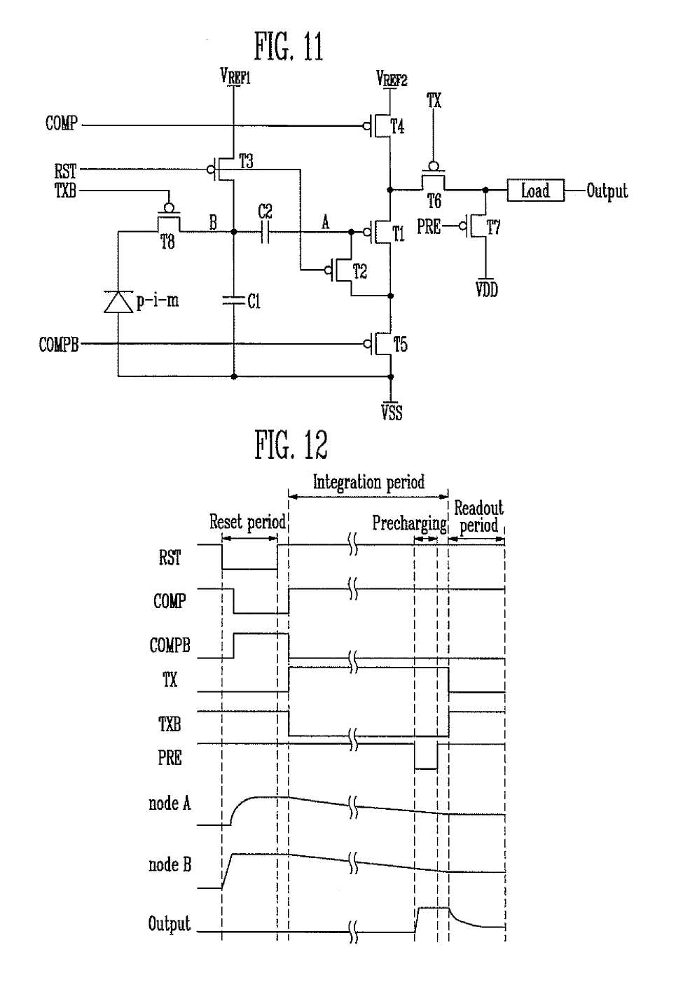

FIG. 11 is a diagram illustrating an example of a detection circuit based on a thin film transistor according to an embodiment, and FIG. 12 is a timing chart of a detection circuit according to an embodiment.

Referring to FIG. 11, a detection circuit of a temperature sensor according to an embodiment may include first transistor T1 through eighth transistor T8 formed on the display panel, a first capacitor C1, a second capacitor C2, and a p-i-m diode. Here a first electrode of the transistors may be a source or drain electrode, and a second electrode may be a drain or source electrode.

The p-i-m diode may be coupled between the second power Vss and the first electrode of the eighth transistor T8, and the second electrode of the eighth transistor T8 may be coupled to a second node B. A gate electrode of the eighth transistor 18 may be coupled to a TXB signal input line. The second electrode of the fifth transistor T5 may be coupled to the second power VSS, the first electrode of the fifth transistor T5 may be coupled to the second electrode of the first transistor T1, and a gate electrode of the fifth transistor T5 may be coupled to a second signal input line COMPB. The second electrode of the second transistor T2 may be coupled to the second electrode of the first transistor T1, the first electrode of the second transistor T2 may be coupled to a first node A, and a gate electrode of the second transistor T2 may be coupled to a reset signal input line RST. The first capacitor C1 may be connected between the second node B and the second power Vss, and the second capacitor C2 may be connected between the first node A and the second node B. The second electrode of the first transistor T1 may be connected to the second electrode of the second transistor 12 and the first electrode of the fifth transistor T5, the first electrode of the first transistor T1 may be connected to the second electrode of the fourth transistor 14, and a gate electrode of the first transistor T1 may be connected to the first node A. The second electrode of the third transistor T3 may be connected to the second node B, the first electrode of the third transistor T3 may be connected to a first reference power VREF1, and a gate electrode of the third transistor 13 may be connected to the reset signal input line RST. The second electrode of the fourth transistor 14 may be connected to the first electrode of the first transistor, the first electrode of the fourth transistor T4 may be connected to a second reference power VREF2, and a gate electrode of the fourth transistor 14 may be connected to the first signal input line COMP. The first electrode of the sixth transistor T6 may be connected to the first electrode of the seventh transistor T7, the second electrode of the sixth transistor 16 may be connected to the first electrode of the first transistor T1, and a gate electrode of the sixth transistor T6 may be connected to a transmission signal input line Tx. The first electrode of the seventh transistor T7 may be connected to the first electrode of the sixth transistor 16, the second electrode of the seventh transistor T7 may be connected to the first power VDD, and a gate electrode may be connected to a pre-charge signal input line PRE. Load may be connected between the first electrode of the seventh transistor T7 and an output terminal.

Referring to FIG. 12, the detection circuit shown in FIG. 11 may operate according to a reset period, an integration period and a read-out period. During the reset period, a reset signal RST may be supplied so that the detection circuit may be initialized. During the integration period, a TXB signal may be input to the gate electrode of the eighth transistor T8 and the leakage current from the p-i-m diode may be stored in the capacitors C1 and C2. During a precharging period included in the integration period, a precharge signal PRE may be supplied to the gate electrode of the seventh transistor T7 so that the seventh transistor T7 may be turned on. During the read-out period, a voltage corresponding to the above leakage current may be output through the output terminal.

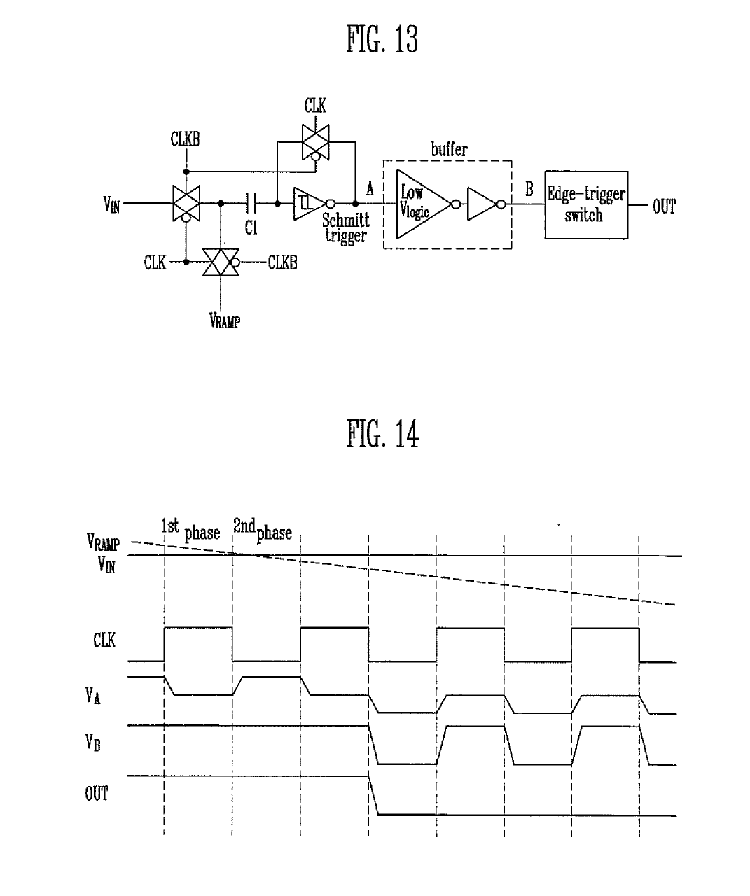

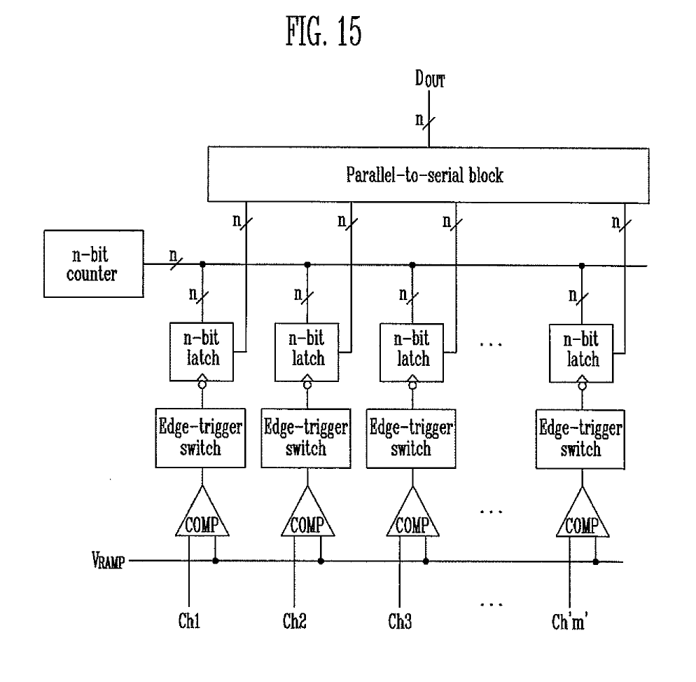

FIG. 13 illustrates an example of a comparator using a Schmitt trigger according to an embodiment, FIG. 14 is a timing chart of a comparator according to an embodiment, and FIG. 15 illustrates an example of an analog-digital converter using a comparator according to an embodiment.

Referring to FIG. 13, a comparator according to an embodiment may include an inverter and a Schmitt trigger. Furthermore, one of the inverters of buffer may be a low logic voltage low Vlogic inverter, so the output voltage of the comparator may be high during a first phase operation as shown in FIG. 14. It may further include an edge trigger switch, preventing fluctuation of the output voltage.

FIG. 15 illustrates an example of a multi-channel analog-digital converter (ADC). Here, an n-bit latch and a comparator may be located in each channel, and there may be only one n-bit counter in the multi-channel ADC. Parallel to serial blocks consist of n-bit shift resisters in order to minimize the interface line.

In a display device according to an embodiment, temperature sensors may be formed on the display panel to determine whether an overcurrent is supplied from the power supply unit. In other words, temperature detecting units may be located below or near power supply lines in order to detect temperature increases in the wiring due to an overcurrent. When the temperature of the wiring is at the critical value or higher, it may be determined that there has been an overcurrent. Here, the temperature sensor, a detection circuit, and a comparator circuit may be configured as a TFT and be integrated into a panel. As a result, it may be determined whether an overcurrent has been generated, while also, reducing costs.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, components, and/or elements described in connection with a particular embodiment may be used singly or in combination with features, characteristics, components, and/or elements described in connection with other embodiments unless otherwise specifically indicated. Accordingly, it will be understood by those of skill in the art that various suitable changes in form and details may be made without departing from the spirit and scope of the present invention as set forth in the following claims and their equivalents.

What is claimed is:

1. A display panel comprising:
a substrate
a plurality of pixels on the substrate, the plurality of pixels comprising an emitting element;
a power supply line on the substrate, the power supply line being configured to receive power supplied from a power supply; and
a temperature sensor at a peripheral region of the power supply line and configured to sense a temperature of the power supply line.

2. The display panel as claimed in claim 1,
wherein the temperature sensor comprises a p-type-intrinsic-metal (p-i-m) diode or a p-type intrinsic n-type (p-i-n) diode.

3. The display panel as claimed in claim 1,
wherein the temperature sensor is between the substrate and the power supply line.

4. The display panel as claimed in claim 1, wherein the power supply line comprises:
a first power supply line configured to receive a first power from the power supply; and
a second power supply line configured to receive a second power from the power supply.

5. The display panel as claimed in claim 4, wherein the temperature sensor comprises:
a first temperature sensor at a peripheral region of the first power supply line, the first temperature sensor being configured to detect a temperature of the first power supply line; and
a second temperature sensor at a peripheral region of the second power supply line, the second temperature sensor being configured to sense a temperature of the second power supply line.

6. The display panel as claimed in claim 1, wherein the temperature sensor comprises:
a temperature sensing sensor configured to change a leakage current according to the temperature of the power supply line;
a detection circuit configured to convert the leakage current of the temperature sensing sensor into a voltage; and
a comparator configured to compare the voltage with a reference voltage and determine whether an overcurrent is generated.

7. The display panel as claimed in claim 6,
wherein the comparator is configured to transmit signals to interrupt power supplied from the power supply to the power supply line when the voltage is greater than the reference voltage.

8. A display device comprising:
a display panel;
a data driver configured to supply data signals to the display panel;
a scan driver configured to supply scan signals to the display panel; and
a power supply configured to supply power to the display panel,
wherein the display panel comprises:
a substrate;
a plurality of pixels on the substrate, the plurality of pixels comprising an emitting element;
a power supply line on the substrate, the power supply line being configured to receive power supplied from the power supply; and
a temperature sensor at a peripheral region of the power supply line and configured to sense a temperature of the power supply line.

9. The display device as claimed in claim 8,
wherein the temperature sensor comprises a p-i-m diode or a p-i-n diode.

10. The display device as claimed in claim 8,
wherein the temperature sensor is between the substrate and the power supply line.

11. The display device as claimed in claim 8, wherein the power supply line comprises:
a first power supply line configured to receive a first power supplied from the power supply; and
a second power supply line configured to receive a second power supplied from the power supply.

12. The display device as claimed in claim 11, wherein the temperature sensor comprises:
a first temperature sensor at a peripheral region of the first power supply line, the first temperature sensor being configured to sense the temperature of the first power supply line; and
a second temperatures sensor at a peripheral region of the second power supply line, the second temperatures sensor being configured to sense the temperature of the second power supply line.

13. The display device as claimed in claim 8, wherein the temperature sensor comprises:
a temperature sensing sensor configured to change a leakage current according to the temperature of the power supply line;
a detection circuit configured to convert the leakage current of the temperature sensing sensor into a voltage; and
a comparator configured to compare the voltage with a reference voltage and determine whether an overcurrent is generated.

14. The display device as claimed in claim 13,
wherein the comparator is configured to transmit a signal to interrupt current supplied by the power supply to the power supply line when the voltage is greater than the reference voltage.
